(19) United States
(12) Patent Application Publication
(10) Pub. No.: US 2015/0153515 A1
(43) Pub. Date: Jun. 4, 2015

(54) OPTICAL FIBER CONNECTOR

(71) Applicant: HON HAI PRECISION INDUSTRY CO., LTD., New Taipei (TW)

(72) Inventor: CHANG-WEI KUO, Tu-Cheng (TW)

(21) Appl. No.: 14/549,831

(22) Filed: Nov. 21, 2014

(30) Foreign Application Priority Data
Nov. 30, 2013 (CN) 201310621890.3

(51) Int. Cl. G02B 6/38

(52) U.S. Cl. CPC G02B 6/3807

(57) ABSTRACT

An optical fiber connector includes a first component and a second component. The first component has the first receiving groove and the limiting slot connecting to the first receiving groove. The first component includes a first positioning portion. The first positioning portion is arranged into the first receiving groove. The first positioning portion has a plurality of first positioning grooves parallel to each other. The limiting slot has a plurality of receiving holes parallel to each other. Each receiving hole is corresponding to each first positioning groove. A plurality of optical fibers having the cladding layer is received into the first positioning grooves. A plurality of cores of optical fibers with the cladding layer removed is received into the receiving holes.

### FIELD

The present disclosure relates to a connector, and more particularly, to an optical fiber connector.

### BACKGROUND

An optical fiber includes a core and a cladding layer covering the core. In order to prevent the cladding layer from affecting transmission of light in the core, the cladding layer near an end of the optical fiber is removed and the core is exposed when the optical fiber is assembled into the optical fiber connector. Because an outside diameter of the core is smaller than that of cladding layer, a receiving hole is provided in a connector to match with the hole dimension of the cladding layer in order for the core to fit precisely.

### BRIEF DESCRIPTION OF THE DRAWINGS

Implementations of the present technology will now be described, by way of example only, with reference to the attached figures.

FIG. 1 is a isometric view of an optical fiber connector in accordance with an embodiment of the disclosure;

FIG. 2 is an exploded, isometric view of the optical fiber connector of FIG. 1;

FIG. 3 is another exploded, isometric view of the optical fiber connector of FIG. 1, viewed from a different angle; and

FIG. 4 is a cross section view of the optical fiber connector along a line IV-IV of FIG. 1

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. The following disclosure is described in relation to an optical fiber connector.

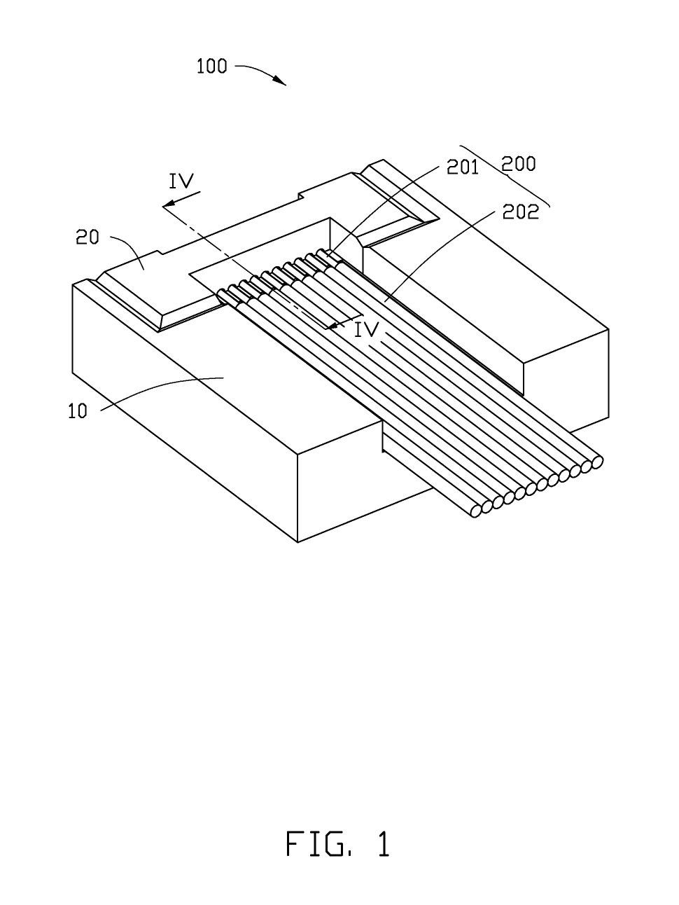

According to one example, FIGS. 1 to 4 illustrate an optical fiber connector 100 used for connecting an optical fiber 200. The optical fiber 200 includes a core 201 and a cladding layer 202 covering the core 201. The optical fiber connector 100 includes a first component 10 and a second component 20 detachably connected to the first component 10.

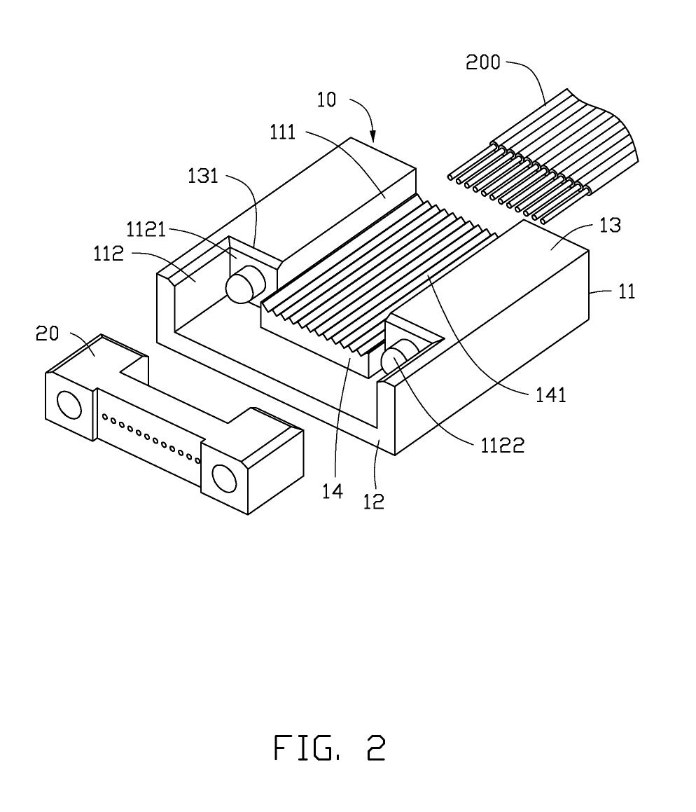

According to one example, FIG. 2 illustrates that the first component 10 is rectangular-shaped. The first component 10 has a front end surface 11, a back end surface 12 opposite the front end surface 11, an upper surface 13 connected between the front end surface 11 and the back end surface 12, a first receiving groove 111 connected to the front end surface 11 on the upper surface 13, and a limiting slot 112 connected to the back end surface 12. The limiting slot 112 is connected to the first receiving groove 111. The first component 10 includes a first positioning portion 14. The first positioning portion 14 is arranged at the first receiving groove 111. An end of the first positioning portion 14 is substantially co-planar with the front end surface 11. The other end of the first positioning portion 14 extends into the limiting slot 112. A plurality of first positioning grooves 141 are defined on one side of the first positioning portion 14 toward the upper surface 13. The plurality of first positioning grooves 141 is parallel to each other. Each first positioning groove 141 is a V-shaped structure. According to one example, a distance between each two adjacent first positioning grooves 141 is equal. The limiting slot 112 includes an inside surface 1121 parallel to both the front end surface 11 and the back end surface 12. Two positioning pillars 1122 extend vertically from the inside surface 1121. A first chamfer 131 is arranged on an edge of the upper surface 13 contacting with the second component 20.

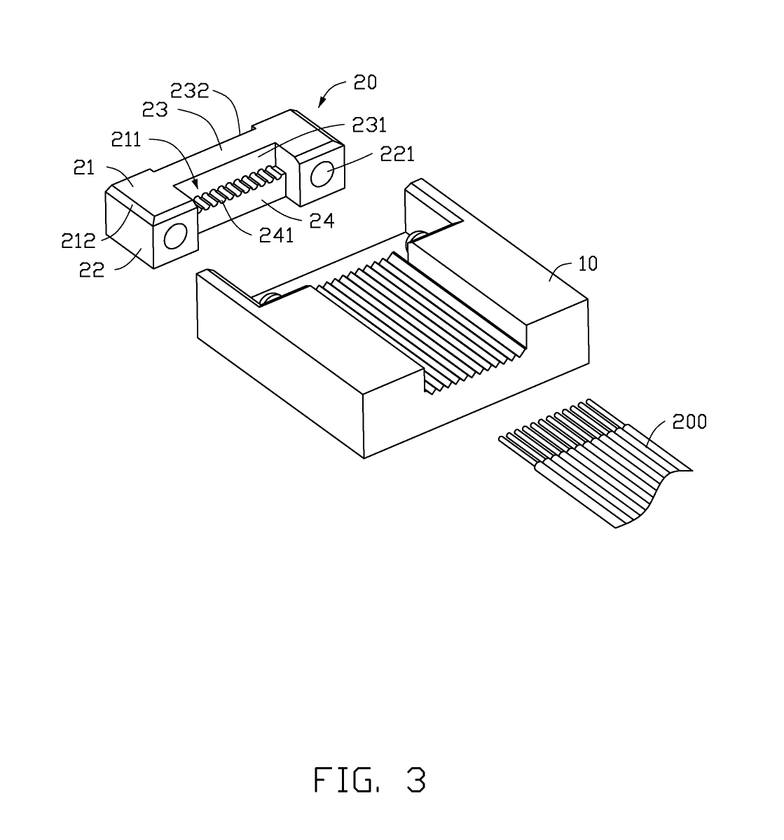

According to one example, FIG. 3 illustrates that the second component 20 is rectangular-shaped. A dimension of the second component 20 corresponds to a dimension of the limiting slot 112 illustrated in FIG. 2. The second component 20 has an upper end surface 21. The second component 20 includes two connecting portions 22, an insertion portion 23 and a second positioning portion 24. The insertion portion 23 connects between two connecting portions 22. A second receiving groove 211 is formed by the insertion portion 23 and two connecting portions 22. The second receiving groove 211 connects to the upper end surface 21. The second positioning portion 24 is arranged into the second receiving groove 211. The insertion portion 23 includes a first surface 231 near the second positioning portion 24 and a second surface 232 opposite to the first surface 231. The insertion portion 23 includes a plurality of receiving holes 223 penetrating between the first surface 231 and the second surface 232. According to one example, a distance between each two receiving holes 223 is equal. A portion of the one receiving hole 223 near the first surface 231 is conical shape. Each connecting portion 22 has a respective positioning hole 221. According to one example, an extension direction of the positioning hole 221 is parallel to an extension direction of the receiving hole 223. One side of the second positioning portion 24 toward the upper end surface 21 has a plurality of the second positioning grooves 241. Each second positioning groove 241 is parallel to each other. Each second positioning groove 241 is a V-shape structure. A distance between each two adjacent second positioning grooves 241 is equal. The second positioning groove 241 corresponds to the receiving hole 223 and interconnects with the receiving hole 223. A number of the second positioning grooves 241 are equal to the number of first positioning grooves 141. A number of the receiving holes 223 are equal to the number of first positioning grooves 141. A second chamfer 212 is arranged at an edge of the upper end surface 21 contacting with the first component 10.

During assembly, the second component 20 is received in the limiting slot 112. The positioning pillar 1122 is received in the positioning hole 221. The upper surface 13 and the upper end surface 21 are on the same plane. The connecting portion 22 contacts with the inside surface 1121. The first positioning portion 14 contacts with the second positioning portion 24. According to one example, the first positioning grooves 141 are aligned with the second positioning grooves 241. Upon assembly, the second positioning grooves 241 correspond to the first positioning grooves 141.

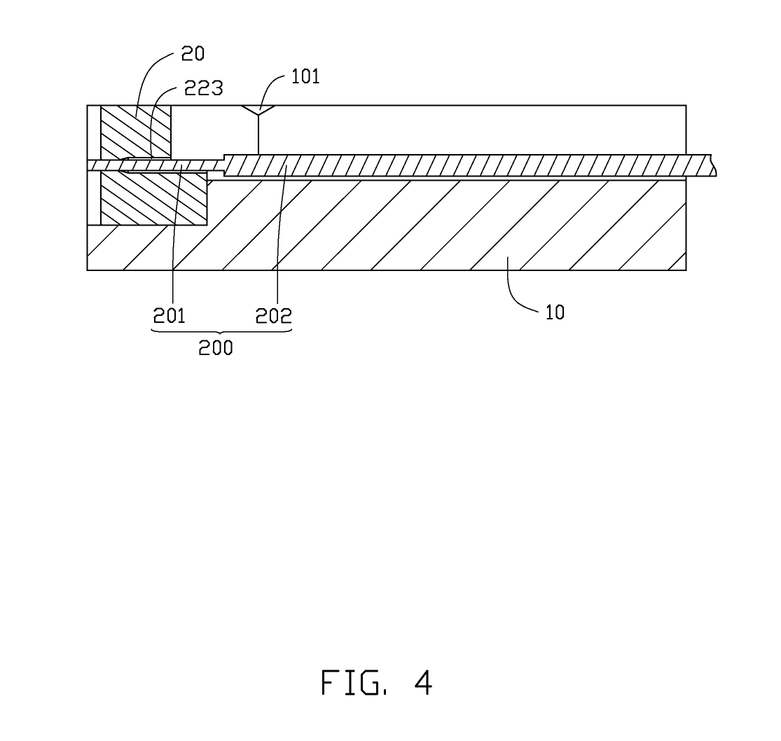

With reference to FIG. 4, a dispensing groove 101 is formed by the first chamfer 131 of the first component 10 and the second chamfer 212 of the second component 20. The first component 10 is fixed to the second component 20 by adhesive. During assembly, a plurality of optical fibers 200 including the cladding layer 202 are received into the first positioning grooves 141. The cores 201 of the optical fiber 200, with the cladding layer 202 removed, are received in the second positioning groove 241 and are inserted into the receiving hole 223. According to one example, the cladding layer 223 may be removed by mechanical or chemical methods known in the art.

The disclosure provides an optical fiber connector 100 in which the first component 10 that receives the optical fiber 200 including the cladding layer 202 is separable from the second component 20 that receives the core 201 with the cladding layer 202 removed. Thus, the first positioning grooves 141 of the first component 10 and the receiving hole 223 of the second component 20 may be molded separately.

The embodiments shown and described above are only examples. Any details that are found in the art are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including, the full extent established by the broad general meaning of the terms used in the claims. It will therefore be appreciated that the embodiments described above may be modified within the scope of the claims.

What is claimed is:

1. An optical fiber connector used for connecting optical fiber comprising:
a first component having a first receiving groove, a limiting slot connecting to the first receiving groove, a first positioning portion arranged into the first receiving groove and a plurality of first positioning grooves arranged parallel to each other on the first positioning portion;
and a second component detachably coupled to the first component, the second component having a plurality of receiving holes positioned parallel to each other, the receiving holes extending in a same direction as the first positioning grooves, wherein the plurality of receiving holes correspond to the plurality of first positioning groove.

2. The optical fiber connector of claim 1, wherein the first component comprises a front end surface, a back end surface opposite to the front end surface, an upper surface connecting to the front end surface and back end surface, the first receiving groove connecting to the front end surface and the upper surface, and the limiting slot connecting to the back end surface and the upper surface.

3. The optical fiber connector of claim 2, wherein one end of the first positioning portion is coplanar with the front end surface, and the other end of the first positioning portion extends into the limiting slot.

4. The optical fiber connector of claim 3, wherein the second component includes two connecting portions, an insertion portion between the two connecting portions, a second positioning portion, and a second receiving groove formed proximate to the two connecting portions and the insertion portion, the second positioning portion being arranged into the second receiving groove.

5. The optical fiber connector of claim 4, wherein a plurality of the second positioning grooves positioned parallel to each other are arranged on the second positioning portion, the receiving hole is arranged into the insertion portion, and the second positioning grooves correspond to the first positioning grooves.

6. The optical fiber connector of claim 4, wherein the limiting slot includes an inside surface positioned parallel to the front end surface and back end surface, two positioning pillars extend vertically from the inside surface, each connecting portion having a positioning hole, the positioning pillar being received into the positioning hole.

7. The optical fiber connector of claim 6, wherein the connecting portion contacts the corresponding inside surface and the first position portion contacts the corresponding second positioning portion.

8. The optical fiber connector of claim 6, wherein the insertion portion includes a first surface near the second positioning portion and a second surface opposite to the first surface, the receiving hole penetrates through between the first surface and the second surface, and the portion of the receiving hole near the first surface is conical.

9. The optical fiber connector of claim 2, wherein the second component includes an upper end surface that is coplanar with the upper surface of the first component, a first chamfer being arranged at an edge of the upper surface that contacts the second component, a second chamfer being arranged at an edge of the upper end surface that contacts the first component, and a dispensing groove is formed by the first chamfer and the second chamfer.
